(19) United States
(12) Patent Application Publication
(10) Pub. No.: US 2003/0048222 A1
(43) Pub. Date: Mar. 13, 2003

(54) Calibration of an earth station antenna using data provided by a satellite

(76) Inventors: John Schmid, Gaithersburg, MD (US); Stan Kay, Rockville, MD (US); Russell Fang, Potomac, MD (US); Gregory Ernst, Gaithersburg, MD (US); Mark Steber, Frederick, MD (US); Kumud Patel, Germantown, MD (US); Jeffrey Singer, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/147,120

(22) Filed: May 16, 2002

Related U.S. Application Data
(60) Provisional application No. 60/318,288, filed on Sep. 10, 2001.

(51) Int. Cl. H01Q 3/00

(52) U.S. Cl. 342/359

(57) ABSTRACT

An antenna of an earth station is adjusted at a predetermined interval for calibration purposes. A notification of clear sky is received. Signals from a satellite are received upon the receiving of the notification of clear sky. The antenna of the earth station is adjusted to point in various directions while receiving the signals from the satellite. A direction is determined where the antenna of the earth station is pointing where the strongest signal is received from the satellite. The antenna of the earth station is positioned to point in the direction where the strongest signal is received by the satellite.

### RELATED APPLICATIONS

This application claims priority to U.S. provisional application serial No. 60/318,288, which is incorporated in its entirety herein by reference.

### FIELD OF INVENTION

This invention relates generally to the field of a method for adjusting an earth station antenna, and more particularly to a method for calibrating an earth station antenna upon notification of clear sky.

### BACKGROUND OF THE INVENTION

Earth stations receive information transmitted from satellites in orbit. An earth station antenna on the surface of the earth serves as a receiver of information from the satellite. A user of the information can expect to receive the requested information via the earth station antenna. For example, the information may be provided to the user by way of a cable provided between the earth station and the user.

Earth station antennas may shift from their satellite pointing locations over time due to weather conditions and mechanical errors, for example. Therefore, earth station antennas are periodically re-calibrated to insure that they are pointing to the best location to receive the strongest possible satellite signal.

The conventional technique in which an earth station antenna is calibrated to be positioned to receive the strongest satellite signal is by using a standard dithering technique. The earth station antenna moves one or two degrees in each angle and in each direction, using the dithering technique, to receive the satellite signal at each of these points. Then, the satellite signal strength in each of these locations is measured, and the direction where the strongest satellite signal is received is the direction in which the earth station antenna is pointed.

This approach seems viable, however it is not totally accurate. There is no guarantee that the satellite signal strength being transmitted from the satellite is constant during the entire dithering process. In addition, there is no guarantee that the sky conditions remain the same during that time. Clouds and various forms of precipitation can alter the measurements and accuracy of the satellite signal. Thus, the conventional technique of positioning an earth station antenna to receive the maximum amount of signal strength from a satellite is not totally accurate.

The inventors have identified certain drawbacks and inefficiencies in the above-described conventional method of re-calibrating an earth station antenna. The re-calibration is not always accurate, therefore, the earth station antenna is not always receiving the strongest signal it may be able to receive.

### SUMMARY OF INVENTION

An embodiment of the present invention is directed to a method of adjusting an antenna of an earth station at a predetermined interval, including the following steps: receiving a notification of clear sky; receiving signals from a satellite upon the receiving of the notification of clear sky; adjusting the antenna of the earth station to point in various directions while receiving the signals from the satellite; determining a direction where the antenna of the earth station is pointing where the strongest signal is received from the satellite; and positioning the antenna of the earth station to point in the direction where the strongest signal is received by the satellite.

In one embodiment, the predetermined interval is determined by calculating a frequency of a need for re-calibration of the antenna of the earth station.

In another embodiment, the satellite is in a geo-synchronous orbit.

In another embodiment, the notification of clear sky signifies that there is no precipitation in the path between the satellite and the earth station.

In yet another embodiment, the notification of clear sky is determined by a radar detecting weather patterns.

In yet a further embodiment, the satellite transmits signals to the earth station for the purposes of re-calibration of the antenna of the earth station.

In another embodiment, the predetermined intervals are determined by calculating how often the antenna of the earth station should be re-calibrated.

Another embodiment of the present invention is directed to a method of adjusting an antenna of an earth station at predetermined intervals including the following steps: determining a length of time equaling the predetermined interval; requesting a notification of clear sky at a beginning of the predetermined interval; receiving a notification of clear sky; receiving signals from a satellite upon the receiving of the notification; adjusting the antenna of the earth station to point in various directions while receiving the signals from the satellite; comparing signal strength of the received signal from the satellite; determining a direction where the antenna of the earth station is pointing where the strongest signal is received from the satellite; and positioning the antenna of the earth station to point in the direction where the strongest signal is received by the satellite.

Yet another embodiment of the present invention is directed to a method of adjusting an antenna of an earth station at predetermined intervals, including the following steps: receiving signals from a satellite upon receiving a notification of clear sky; adjusting the antenna of the earth station to point in various directions while continuously receiving the signals from the satellite upon receiving the notification of clear sky; and positioning the antenna of the earth station to point in the direction where the strongest signal is received by the satellite.

Another embodiment of the present invention is directed to a method of positioning an antenna of an earth station, the method including the following steps: transmitting a signal from the antenna of the earth station to a satellite; demodulating the signal at the satellite; obtaining link characteristic information at the satellite based on information obtained from the demodulated signal; transmitting the link characteristic information from the satellite to the antenna of the earth station; and pointing the antenna of the earth station in a particular direction based on the link characteristic information.

Another embodiment of the present invention is directed to a method of positioning an antenna of an earth station, the method including the following steps: moving the antenna of the earth station to point at various angles; transmitting a signal to a satellite from each of the various angles; demodulating the signal sent to the satellite, by the satellite; obtaining link characteristic information from the demodulated signal by the satellite; transmitting the link characteristic information to the earth station; determining the link characteristic information for each of the various positions of the antenna of the earth station; determining the position of the antenna of the earth station from where the link characteristic information is best; and pointing the antenna of the earth station in a direction based on the position of the antenna of the earth station from where the link characteristic information is best.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a diagrammatic representation illustrating a satellite communication system of the present invention.

FIG. 2 is a flow chart illustrating method steps according to an embodiment of the present invention.

FIG. 3 is a flow chart illustrating method steps according to an embodiment of the present invention.

FIG. 4 is a schematic illustration of the constellation of communications satellites utilized in the present invention.

FIG. 5 is a block diagram illustrating system components used in a method according to an embodiment of the present invention.

FIG. 6 is a diagram illustrating a dithering technique used in a conventional method of calibrating an earth station antenna.

### DETAILED DESCRIPTION OF THE PREFERRED EMBODIMENTS

As described herein with reference to the accompanying drawings, the present invention provides a method for accurately positioning an earth station antenna. To facilitate understanding of the present invention, the following definitions are provided:

Definitions:

Satellite Ephemeris Data: Used to determined the position of a satellite, at successive future time periods. Used to calculate the satellite location by using the known terminal location, computing the local Time of Day, computing range, applying delay calibrations, and finally computing Doppler and delay.

Earth Station Antenna: An antenna that receives signals output from a satellite, and which is coupled to an earth station.

Calibration: An ongoing process that periodically removes accumulated offsets in satellite tracking error. These offsets are largely due to the long term effects of mechanical wear of the earth station tracking elements, earth station foundation settling, slight earth shifting, etc.

Geo-Synchronous Orbit: An orbit in which a satellite moves at the same speed as the earth's rotation; and where the orbit is approximately 22,236 miles above the earth's surface.

Scintillation: A rapid variation of light of a celestial body caused by a turbulence in Earth's atmosphere. A rapid variation of electromagnetic path propagation loss due to turbulence in the earth's atmosphere.

In communication systems between satellites and earth stations, inclement weather and scintillation effects can hinder the communication between them. Conventional antenna tracking systems utilize earth station equipment that transmits and receives satellite signals, makes use of satellite resources to receive and transmit these signals and makes decisions of where to point the earth station antenna based on the received signal strength determinations.

The present invention uses satellite ephemeris data and clear sky notification provided by a satellite network system to align an earth station antenna to a satellite. It also uses link characteristic information in the downlink signal to find the location where the antenna points to with the least amount of error in transmission. The information with satellite ephemeris data and clear sky notification can be sent to the earth station within the downlink sent by the satellite to the earth station that is undergoing calibration. In other words, in an alternative configuration, the clear sky notification can be provided by the satellite network system, as an input to the calibration scheme described herein, based on an earth station receive signal strength. This clear sky determination would be made without the need to be communicatively coupled to a weather radar that could alternatively provide such information, for example.

Several different factors contribute to earth station antennas losing their exact positioning over time. For example, there may be a mechanical error in which the antenna is simply moved a degree east or west from its best position. Weathering can cause an antenna to rust and corrode, which then causes the antenna to move out of its exact positioning. In observing an earth station antenna, its movement patterns, and its need for calibration, an interval is determined. For example, if an earth station antenna is observed, and it is known that every six months the antenna requires re-calibration because after six months, the antenna no longer receiving a strong signal, then the interval for re-calibration is at least every six months. However, waiting until the antenna is badly in need of re-calibration is not the best way to insure accurate readings. The interval may be reduced to below six months, for example, the predetermined interval may be three months. Having an interval of three months would insure that the antenna is always in exact positioning, for this example.

The pre-determined interval is a configurable parameter that is installed during commissioning. It can be changed at any time through external command. Upon calibration, the amount of offset needing correction is observed. At that time, consideration is done to determined whether the automatic calibration interval needs to be changed.

Periodically, earth station antennas need to be calibrated. The process of calibration is intended to precede any effects of mechanical aging or physical settling that could cause the earth station antenna to shift out of its exact alignment with the satellite. Calibration uses the received signal quality measurement equipment located on the satellite. The signal quality measurement equipment is a digital signal processor (DSP) in the satellite which can measure the carrier to noise ratio of the received earth station transmission. There are no fluctuations of the received satellite power because the transmitted uplink power is at a constant level and the calibration process is only performed after receiving clear sky notification. Clear sky notification is provided by the network and is part of the received downlink carrier data packets sent to each of the earth stations. The present invention's method of calibration is advantageous over the conventional calibration techniques, because there is a need to measure received signals and no need to factor in weather and scintillation effects and signal loss due to an error in the pointing direction of the earth station antenna. Weather and scintillation effects are not of any concern, because the calibration process only occurs upon receiving of a notification of clear sky.

The network of the present invention provides communications capabilities that will significantly contribute to the National and Global Information Infrastructures. It provides high data rate communications to customers throughout the United States and most of the rest of the world as well. The system provides true broadband capability, including high speed access to the Internet in particular and high-technology telecommunications in general. The innovative design of the system insures that this capability can be provided at a much lower cost than installing fiber, thereby taking advantage of the distance insensitivity of satellite-based service. It is also particularly attractive at making first and last mile connections, which is a problem with the present copper and optical fiber cable systems. It also makes sure that the satellite signal readings are accurate.

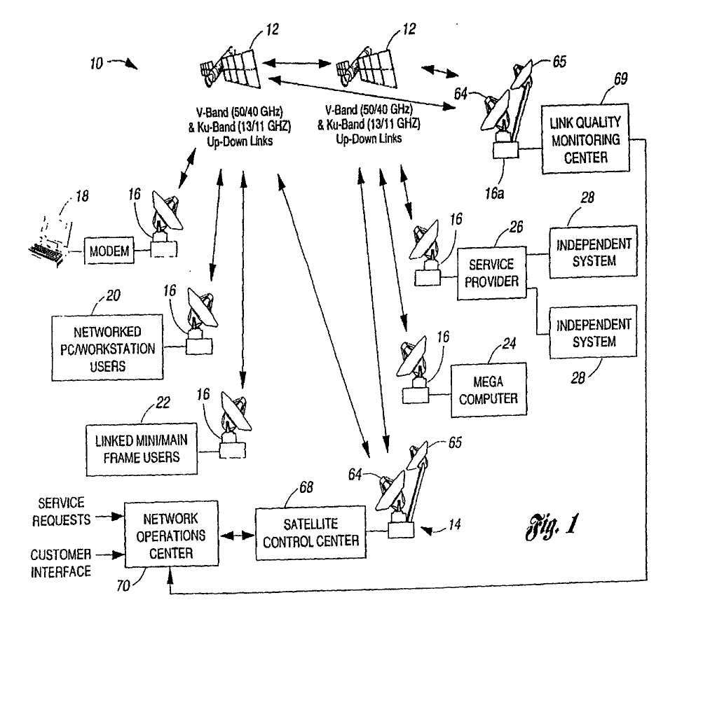

In reference to the figures, FIG. 1 is a diagrammatically illustrated representation of a satellite-based communications network 10 with a typical geometry for practicing the present invention. In general, the network 10 includes a plurality of communications satellites 12 in geo-synchronous orbit or medium earth orbit or low earth orbit, an earth station 14 for controlling and maintaining operation of each of the plurality of satellites 12, and a plurality of user terminals 16. The user terminals 16 may interconnect with a single computer 18, a group of networked PC/Workstation users 20, a group of linked mini/main frame users 22, a mega computer 24, or a service provider 26 that provides service to any number of independent systems 28.

The geo-synchronous satellites 12 are positioned in orbit locations supporting Fixed Satellite Service (FSS) coverage for domestic service and accommodating a primary range of frequencies and a secondary range of frequencies, such as 50/40 GHz V-band as well as 13/11 GHz Ku-band operation. The locations of satellites 12 must accommodate emissions along with other co-orbiting satellites, and must support service to and from high population metropolitan and business areas throughout the world. The preferred orbit locations include four satellites over the U.S., two each at 99° W and 103° W. To accommodate global growth and provide coverage to western Europe, central Europe, Middle East, and Africa, the preferred orbit locations further include eight other satellites, two each at 10° E and one at 63° W, 53° W, 48° E, 63.5° E, 115.4° E and 120.6° E. Each of the satellites 12 are high power satellites having 15-20 KW payload capability, such as an HS 702L High Power Spacecraft manufactured by Hughes Electronics Corporation, the assignee of the present invention. The HS 702L is a three-axis body-stabilized spacecraft that uses a five panel solar array system, along with outboard radiator panels attached to the main body to dissipate heat generated from the high powered Traveling Wave Tubes (TWTs).

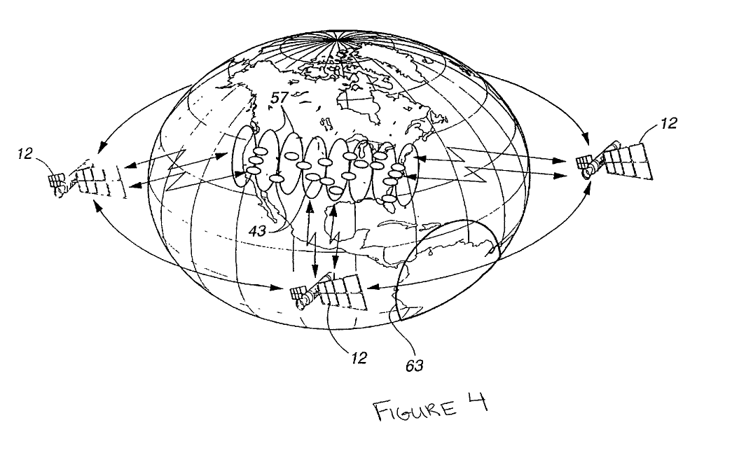

In the present invention, a surface, or area, to receive communications services of the present invention, is divided into a plurality of coverage areas 43, as shown in FIG. 4. Uplink and downlink antennas can support a predetermined number of coverage areas 43, e.g., 200. However, a subset of the plurality of coverage areas 43 is chosen to be used by uplink and downlink antennas to support communications services in predetermined metropolitan areas having heavy traffic. Any type of updated information is transmitted by earth station 14. Thus, usage of available satellite resources, such as weight and power, are utilized for only those beams that are selected and active.

Upon subscribing to the service provided by the network 10 of the present invention, a dedicated communications link is assigned to a user at a source location in one of the coverage areas 43 and a user at a destination location in another one of the coverage areas 43. This dedicated link is assigned an exclusive time channel in one of the frequency channels for transmitting and receiving communications signals.

As with primary communication payload, secondary communication payload includes an uplink antenna having a multi-beam array and a reflector, and a downlink antenna having a corresponding multi-beam array and reflector. Secondary communication coverage is preferably provided by two nadir-mounted dual-gridded reflector antennas, each illuminated by eight diplexed feeds for transmit and receive frequencies. Secondary communication antennas provide a total of eight dual polarized, elliptical area (3°×1°) coverage beams 57, as shown in FIG. 4, for uplink and downlink services. Thus, secondary communication payload provides an eight-fold reuse of the spectrum for a total useable bandwidth of 4 GHz.

To provide for inter-hemisphere interconnectivity, inter-hemisphere link includes a single steerable horn, diplexed for transmit and receive frequencies providing one dual linearly polarized spot beam for uplink and downlink services. Horn transmits a 6°×6°, 13/11 GHz area beam 63 towards the southern hemisphere, allowing thin route coverage of southern regions such as South America, as shown in FIG. 4. This beam may also provide north-south interconnection coverage to areas such as Europe and Africa.

Returning to FIG. 1, user terminals 16 include a primary antenna 64 for communicating with each of the satellites 12 in the primary range of frequencies, such as V-band frequencies. Thus, user terminals support data rates between 1.544 Mbps (equivalent to T1) and 155 Mbps (OC3 equivalent) via V-band antenna 64. Data rates below T1 are accommodated at user terminals 16 by sub-multiplexing the data to T1 (or higher) rates before transmission. Each of the user terminals 16 time-share the FDMA channels, with 100 TDMA channels in each 300 MHz FDMA channel. Since each TDMA channel supports a data rate of 1.544 Mbps, the network 10 provides a data rate of 1.544 Gbps (100×1.544 Mbps×10) for each of the forty effective beams per satellite 12. For each FDMA channel, the channel data rate is 274.8 Mbps, which includes overhead for coding, transport protocol, network signaling, and access management. Uplink operation at each of the user terminals 16 operates in a burst mode at a data rate determined by the full FDMA channel plan.

Thirty watt high power amplifiers (HPA's) operate at saturation in the user terminals 16, with the user terminals 16 in each beam operating time shared on one of ten unique carrier frequencies. Out of band emissions are minimized in each user station 16. Each of the forty 3.0 GHz bandwidth beams is received and down converted, routed through circuit switch, upconverted, and amplified by a TWTA associated with a particular downlink beam. The downlink beams each have ten carriers, one for each FDMA channel. Each TWTA uses linearizers and operates with sufficient output backoff to ensure minimum out of band emissions and inter-modulation products.

User terminals 16a that cannot tolerate the expected loss of transmission due to weather outages further include a secondary communication antenna 65 for transmitting and receiving signals at the secondary range of frequencies. Secondary communication antenna 65 may or may not be the same as the primary communication antenna 64. User terminals 16a subscribing to this type of service include a link quality monitoring center 69 to monitor the quality of service of primary communication payload and routes it to a higher quality link, i.e., secondary communication payload, in the presence of adverse link propagation disturbance. The rerouting of traffic to a higher availability link is accomplished by communicating such conditions to an earth station 14.

The earth station 14 has two functions. Satellite control center 68 manages the health and status of all the satellites 12 and maintains their orbits. The network operations center 70 of earth station 14 provides resource management, fault management, accounting, billing, customer interfacing and service. Network operations center 70 of earth station 14 provides resource management, fault management, accounting, billing, customer interfacing, and service.

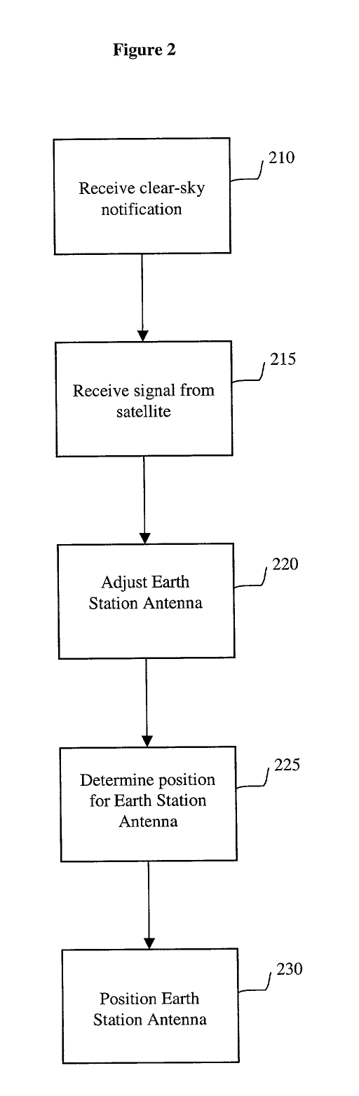

FIG. 2 is a flow chart illustrating method steps according to an embodiment of the present invention. Once a length of time equaling the predetermined interval has been determined, at a beginning of the predetermined interval, there is a request for a notification of clear sky. Once an earth station has determined that it is time for it to re-calibrate, a request is output from the earth station.

The earth station determines the need for calibration, based upon configuration interval commands. It looks to the received signal to learn if clear sky exists. If it is transmitting, the earth station slightly dithers its antenna pointing to determine the best physical position based upon returned satellite power measurements.

Clear sky evaluation is continually performed by the network control center and broadcast to all networked earth station. Upon detecting the need for calibration, the particular earth station simply refers to its received demodulated signal to the presence of the clear sky indicator.

In step 210, an earth station outputs a request for a notification of clear sky. The earth station determines the need for calibration and looks for a signal of clear sky. Clear sky can be determined in a number of ways. For example, some satellites have sensors on them. These sensors have a capability of determining the weather in the earth's atmosphere. After determining a clear sky (e.g., no clouds) using the sensors on the satellite, the satellite sends a notification of clear sky to the earth station. In another example, the earth station sends a notice of clear sky request to a weather radar that detects atmospheric conditions. Upon clear sky notification from the radar to the earth station, an earth station antenna calibration can be performed.

In step 215, the earth station antenna receives signals from the satellite, and in step 220, starts adjusting the earth station antenna to point in various directions (e.g., 0.1 degrees East, West, North and South with respect to a current antenna pointing position) while continuously receiving the satellite signals. The signal strength of the satellite is compared amongst all the different positions of the earth station antenna. In step 225, a direction in which the antenna is pointing where the strongest signal is received from the satellite is determined. In step 230, the earth station antenna is positioned to point in the direction in which the strongest signal from the satellite is received.

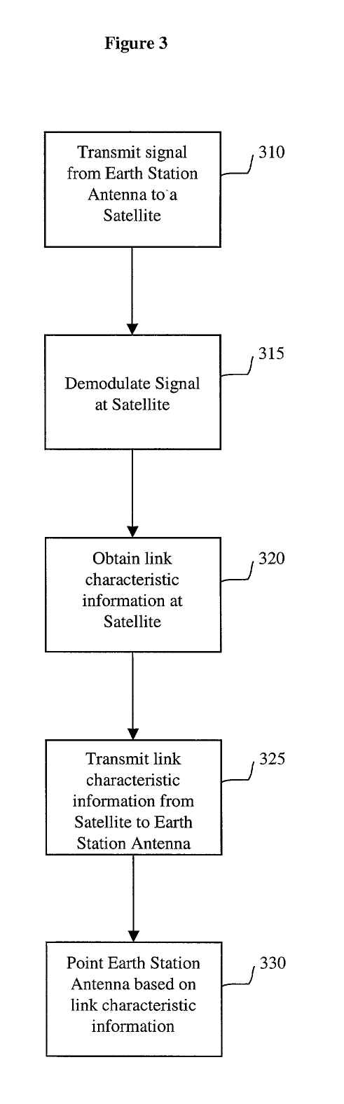

FIG. 3 is a flow chart illustrating method steps according to an embodiment of the present invention. In the method of positioning an earth station antenna to accurately point to a satellite of choice, the earth station antenna is moved around to point to various directions at various angles. In step 310, the earth station transmits a signal to the satellite from each of the various angles in which it is moving. In step 315, the satellite of choice has the capability to demodulate the signal, at site. In step 320, based on the demodulated signal obtained at the satellite, link characteristic information is obtained. Link characteristic information may correspond to bit-error-rate information (BER), for example. The link characteristic information provided is the received carrier to noise (C/N) ratio. The satellite has a ‘power meter’ on board mainly for uplink power level control (ULPC) usage. All transmissions from any earth station terminal to the satellite need to arrive at nominally the same power level for optimum system performance. The received C/N is transmitted back to the appropriate earth station for the ULPC purpose.

For calibration, given clear-sky, the earth station suspends its ULPC operation, dithers the earth station antenna, and then notes the returned power information. Presumably, then, during calibration, the only path attenuation variable is due to antenna pointing action which moves the position about the main beam lobe.

In step 325, the link characteristic information is transmitted from the satellite to the earth station. Based on the link characteristic information received by the earth station, the earth station determines the link characteristic information for each of the various positions it transmitted information to the satellite from. A determination is then made on the position of the earth station antenna from where the link characteristic information is best, meaning the data with the least amount of error, for example. In step 330, the earth station antenna is pointed in the direction based on the position of the earth station antenna from where the link characteristic information is best.

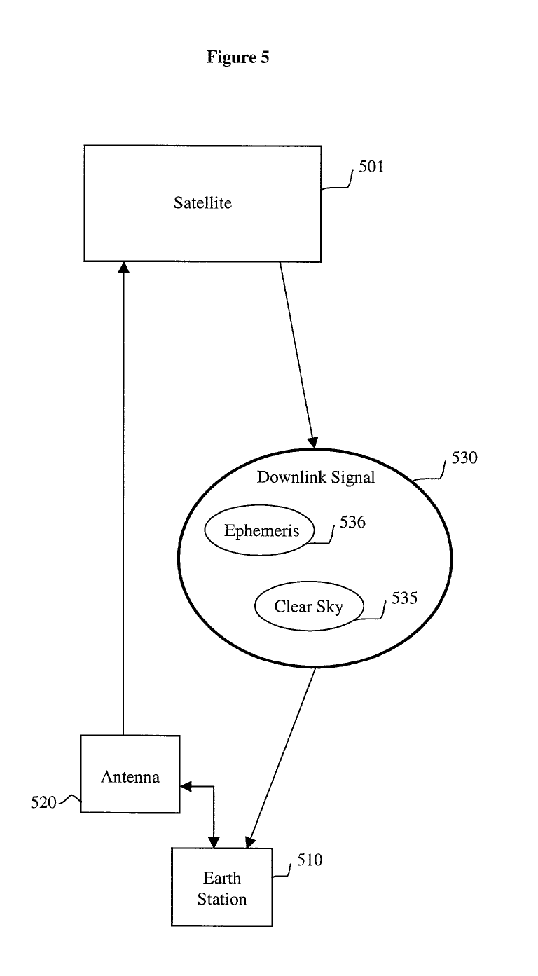

FIG. 5 is a block diagram illustrating system components used in a method according to an embodiment of the present invention. A satellite 501 transmits a downlink signal 530 to the earth station 510. The downlink signal 530 may contain clear sky notification 535 and satellite ephemeris data 536. The earth station antenna 520 is adjusted to point in different angles and directions while the satellite 501 is continuously or periodically transmitting the signal 530 to the earth station 510. Once the earth station 510 has determined the best direction the earth station antenna 520 should point in, the earth station antenna 520 is positioned to point in that direction. The direction chosen is the direction in which the antenna receives the strongest signal from the satellite 501. In another embodiment, the direction chosen is the direction in which the antenna receives data from the satellite 501 with the least amount of error.

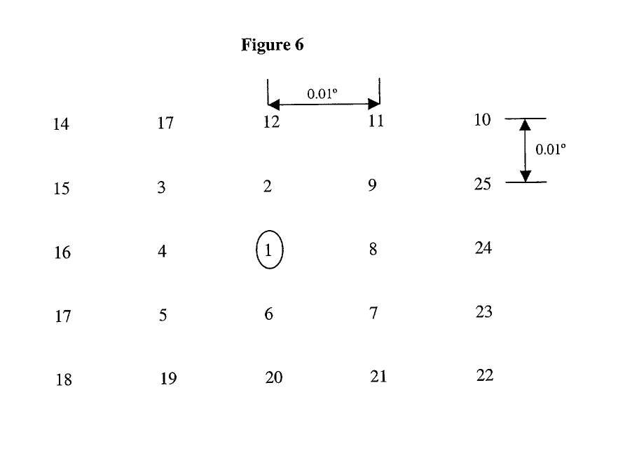

FIG. 6 is a diagram illustrating an example of a dithering technique used in a conventional method of calibrating an earth station antenna 520. Position 1 is the current earth station antenna 520 pointing location. During calibration, the earth station antenna 520 moves, or dithers, from point to point. It starts at position 1, moves to 2, then to 3, and so on until position 25 is reached. The earth station antenna 520 remains at each point for a specific and necessary period of time, e.g., 1-5 msec. This time period is long enough to receive signals sent from the satellite 501. The present invention uses this dithering technique as well, but only after a notice of clear sky is received.

Other embodiments of the present invention will be apparent to those skilled in the art from a consideration of the specification and the practice of the invention disclosed herein. It is intended that the specification be considered as exemplary only, with the true scope and spirit of the invention being indicated by the following claims. For example, the present invention is very applicable to narrow band, high frequency satellite systems, since earth station antenna calibration must be precisely performed to maintain such systems in an operable mode.

What is claimed is:

1. A method of adjusting an antenna of an earth station at a predetermined interval, comprising the steps of:
receiving a notification of clear sky;
receiving signals from a satellite upon the receiving of the notification of clear sky;
adjusting the antenna of the earth station to point in various directions while receiving the signals from the satellite;
determining a direction where the antenna of the earth station is pointing where the strongest signal is received from the satellite; and
positioning the antenna of the earth station to point in the direction where the strongest signal is received by the satellite.

2. The method according to claim 1, wherein the predetermined interval is determined by calculating a frequency of a need for re-calibration of the antenna of the earth station.

3. The method according to claim 1, wherein the satellite is in a geo-synchronous orbit.

4. The method according to claim 1, where the notification of clear sky signifies that there is no precipitation in the path between the satellite and the earth station.

5. The method according to claim 1, wherein the notification of clear sky is determined by a radar detecting weather patterns.

6. The method according to claim 1, wherein the satellite transmits signals to the earth station for the purposes of re-calibration of the antenna of the earth station.

7. The method according to claim 1, wherein the predetermined intervals are determined by calculating how often the antenna of the earth station should be re-calibrated.

8. A method of adjusting an antenna of an earth station at predetermined intervals comprising the steps of:
determining a length of time equaling the predetermined interval;
requesting a notification of clear sky at a beginning of the predetermined interval;
receiving a notification of clear sky;
receiving signals from a satellite upon the receiving of the notification;
adjusting the antenna of the earth station to point in various directions while receiving the signals from the satellite;
comparing signal strength of the received signal from the satellite;
determining a direction where the antenna of the earth station is pointing where the strongest signal is received from the satellite; and
positioning the antenna of the earth station to point in the direction where the strongest signal is received by the satellite.

9. The method according to claim 8, wherein the length of time equaling the predetermined interval is determined by calculating a frequency of a need for re-calibration of the antenna of the earth station.

10. The method according to claim 8, wherein the satellite is in a geo-synchronous orbit.

11. The method according to claim 8, wherein the notification of clear sky signifies that there is no precipitation in the path between the satellite and the earth station.

12. The method according to claim 8, wherein the notification of clear sky is determined by a radar detecting weather patterns.

13. The method according to claim 8, wherein the satellite transmits signals to the earth station for the purposes of re-calibration of the antenna of the earth station.

14. The method according to claim 8, wherein the predetermined intervals are determined by calculating how often the antenna of the earth station should be re-calibrated.

15. A method of adjusting an antenna of an earth station at predetermined intervals, comprising the steps of:
receiving signals from a satellite upon a receiving of a notification of clear sky;
adjusting the antenna of the earth station to point in various directions while continuously receiving the signals from the satellite upon a receiving of a notification of clear sky; and
positioning the antenna of the earth station to point in the direction where the strongest signal is received by the satellite.

16. The method according to claim 15, wherein the predetermined interval is determined by calculating a frequency of a need for re-calibration of the antenna of the earth station.

17. The method according to claim 15, wherein the satellite is in a geo-synchronous orbit.

18. The method according to claim 15, wherein the notification of clear sky signifies that there is no precipitation in the path between the satellite and the earth station.

19. The method according to claim 15, wherein the notification of clear sky is determined by a radar detecting weather patterns.

20. The method according to claim 15, wherein the satellite transmits signals to the earth station for the purposes of re-calibration of the antenna of the earth station.

21. The method according to claim 15, wherein the predetermined intervals are determined by calculating how often the antenna of the earth station should be re-calibrated.

22. A method of positioning an antenna of an earth station, the method comprising the steps of:
transmitting a signal from the antenna of the earth station to a satellite;
demodulating the signal at the satellite;
obtaining link characteristic information at the satellite based on information obtained from the demodulated signal;
transmitting the link characteristic information from the satellite to the antenna of the earth station; and
pointing the antenna of the earth station in a particular direction based on the link characteristic information.

23. The method according to claim 22, wherein the signal transmitted to the satellite is transmitted periodically.

24. The method according to claim 22, wherein the signal transmitted to the satellite is transmitted at re-calibration.

25. The method according to claim 22, wherein the signal transmitted to a satellite is transmitted at pre-determined intervals.

26. The method according to claim 22, wherein the satellite is in a geo-synchronous orbit.

27. The method according to claim 22, wherein the received signal is demodulated into bits, by the satellite.

28. The method according to claim 22, wherein the link characteristic information includes bit-error-rate information.

29. A method of positioning an antenna of an earth station, the method comprising the steps of:
moving the antenna of the earth station to point at various angles;
transmitting a signal to a satellite from each of the various angles;
demodulating the signal sent to the satellite, by the satellite;
obtaining link characteristic information from the demodulated signal by the satellite;
transmitting the link characteristic information to the earth station;
determining the link characteristic information for each of the various positions of the antenna of the earth station;
determining the position of the antenna of the earth station from where the link characteristic information is best; and
pointing the antenna of the earth station in a direction based on the position of the antenna of the earth station from where the link characteristic information is best.

30. The method according to claim 29, wherein the signal transmitted to the satellite is transmitted periodically.

31. The method according to claim 29, wherein the signal transmitted to the satellite is transmitted at re-calibration.

32. The method according to claim 29, wherein the signal transmitted to the satellite is transmitted at pre-determined intervals.

33. The method according to claim 29, wherein the satellite is in a geo-synchronous orbit.

34. The method according to claim 29, wherein the demodulated signal is demodulated into bits, by the satellite.

35. The method according to claim 29, wherein the link characteristic information includes bit-error-rate information.
